(19) United States
(12) Patent Application Publication
(10) Pub. No.: US 2004/0111903 A1
(43) Pub. Date: Jun. 17, 2004

(54) System and method for dynamically marking athletic fields using a hand held user interface

(76) Inventor: Alan Amron, Syosset, NY (US)

Correspondence Address: Brian K. Dinicola, 34 Avenue E., Monroe Twp, NJ, 08831, US

(21) Appl. No.: 10/320,304

(22) Filed: Dec. 16, 2002

(51) Int. Cl. G01C 15/00

(52) U.S. Cl. 33/289

(57) ABSTRACT

A system for dynamically marking, with a temporary visible line, an athletic field surface, wherein the field has a first end, a second end, a first lateral boundary and a second lateral boundary. The system includes a laser source capable of producing a beam of radiation, and a displaceable actuator operatively associated with the laser source and adapted to direct the laser beam onto the athletic field surface. A controller including an electronic processor is programmed to cause displacement of the actuator sufficient to cause a visible line, extending from the first lateral boundary to the second lateral boundary, to appear and move between opposite ends of the athletic field surface. A portable, handheld user interface, which includes a wireless communication link, allows a single supervisory official to establish at least unidirectional communication with the controller. The controller responds to transmissions received from the interface by causing the visible line to advance to any position, selected by the official, between the first end and the second end of the athletic field.

### BACKGROUND OF THE INVENTION

1. Field of the Invention

This invention relates generally to devices for marking athletic fields during sporting events and, more particularly, to a system and method of using a hand-held interface to direct the movement of one or more movable light beams so as to provide an accurate line of demarcation during football games.

2. Discussion of the Prior Art

In athletic events such as football games, an important line of demarcation is the first “down” marker—a line that is located ten yards from the starting point for a series of offensive plays or downs. If the ball is not moved at least ten yards in four “downs” or plays, the team on offense loses possession of the ball. Presently, this ten-yard distance is determined by a set of chains held in position along the sidelines, with one stake or marker placed at approximately the point of the initial line of scrimmage. A supervisory official rules on the precise position of the ball after each ball—with that ruling constituting a determination of whether or not the offensive team has advanced from its previous field position.

Frequently, during play, the offensive team advances approximately 10 yards, and in such a situation, a “measurement” is made using the chains. The chain crew attempts to move parallel to the yard lines, so that when the marker is placed in mid-field, it is located at the same point as it was on the sidelines. Obviously, such an antiquated procedure is quite time consuming and inaccurate, and in view of the extreme importance of such a measurement, is unwarranted. A number of approaches have therefore been proposed to simplify the process.

In U.S. Pat. No. 3,741,662, for example, it is proposed to use multiple low-intensity light beams to produce a constant, visible wall of light. The beams serve to visually demarcate a scoring or score-advancing line wherein movement through the wall is of significance in playing the game. Each light beam emitting source is disposed within a carrier that is linearly moved, along a set of guide rails, in directions parallel to and outside of a boundary line of the playing area. That is, the light beam is directed horizontally from outside the playing area and is reciprocated vertically to create and maintain the vertical wall of light. While this approach represents a potential advance, in terms of accuracy, over the aforementioned chain-marker procedure, it is impractical for situations in which space on the sidelines is limited. Moreover, manual positioning of the beam-carriers requires the assignment of a dedicated ground crew and the position operation has been deemed too slow and cumbersome to be practical.

In U.S. Pat. No. 4,090,708, a number of somewhat similar arrangements are disclosed. In a first embodiment, a single laser beam is configured to provide a luminous horizontal segment directed across the playing area, acting as an overhead line of demarcation in combination with a relatively lower parallel luminous segment of the same beam which is reflected reversely across the playing area to provide a ground-level demarcation line. Alternatively, two oppositely traveling light beams having a pair of horizontal luminous segments serve as a composite over-head demarcation line. These are employed in combination with a second pair of horizontal, relatively lower, luminous segments of the same beams that serve as a ground-level demarcation line.

Due to their complexity and difficulties in implementation and use, neither of the aforementioned approaches has met with any degree of commercial success. Thus, while viewers of televised football games are now able to see a digitally superimposed line of demarcation—representative of the first down line marker on the field, that enhancement has heretofore eluded those members of the audience actually present at the stadium. A need therefore exists for a system capable of visibly displaying a line of demarcation at any desired location on an athletic field and characterized by a simple, easy to use, portable user interface.

### SUMMARY OF THE INVENTION

The aforementioned deficiencies are addressed, and an advance is made in the art, by a system for dynamically marking, with a temporary visible line, an athletic field surface, wherein the field has a first end, a second end, a first lateral boundary and a second lateral boundary. The system includes a laser projector capable of producing a beam of radiation, and at least one displaceable actuator operatively associated with the laser source and adapted to direct the laser beam onto the athletic field surface. The laser projector includes a scanning mechanism adapted to sweep the beam along a path designed to project a visible line onto the athletic field. A controller is configured to cause a displacement of the actuator sufficient to cause the visible line, extending from the first lateral boundary to the second lateral boundary, to appear on and move to a desired position on the athletic field surface. Where the laser source of the laser projector is configured to emit light at a wavelength within the visible band of the electromagnetic spectrum, a shutter mechanism—designed to block light from exiting the laser projector in the event of a malfunction of the scanning mechanism—prevents the beam from being directed at the eye of an individual on the field long enough to cause injury.

A portable, handheld user interface, which includes a wireless communication link, allows a single supervisory official to establish at least unidirectional communication with the controller. The controller responds to transmissions received from the interface by causing the visible line to advance to any position, selected by the official, between the first end and the second end of the athletic field. In accordance with an especially preferred embodiment of the present invention adapted for use during football games, the interface includes a rotary mechanical operator for producing finely controlled movements of the visible line and momentary contact pushbutton operators for quickly but coarsely controlling the movements of the visible line. An optional refinement includes a mechanical operator adapted to issue a “last position” in memory command, whereby a previous position of the actuator—corresponding to a last “fixed” position of the visible line—is stored in memory and the process of advancing the visible line to a new first down location can be re-initialized by actuating the last position operator to direct the visible line back to this position. Still another refinement includes at least one mechanical operator such as a pushbutton which, when depressed, causes the actuator to advance (or reverse) the projected visible line by a predetermined distance (e.g., forward ten yards for a new first down, or back five or fifteen yards for a predetermined penalty).

### BRIEF DESCRIPTION OF THE DRAWINGS

The invention will be further described with reference to embodiments thereof, illustrated by way of example on the accompanying drawings in which:

FIG. 1 is a plan view showing first and second typical athletic field installations for a remotely operated, line demarcation system constructed in accordance with an illustrative embodiment of the present invention;

FIG. 2 is a block schematic diagram depicting the respective functional components of a remotely operated, line demarcation system constructed in accordance with an illustrative embodiment of the present invention;

FIG. 3 is a block schematic diagram depicting an exemplary actuator module adapted to direct the beam output of a laser source at the athletic field so as to produce a visible line at any desired location between a first goal line and a second goal line;

FIG. 4 is a block schematic diagram depicting an exemplary communications interface adapted to establish a wireless communication link between the line demarcation system and a hand-held, portable remote control user interface;

FIG. 5 is a block schematic diagram depicting an exemplary controller that is responsive to commands received from the remote control user interface to direct the operation of both the actuator module and the laser source;

FIG. 6A is a block schematic diagram depicting the functional components of a hand-held, user interface constructed in accordance with the present invention; and

FIG. 6B is a block schematic diagram depicting the external features of a hand-held, user interface constructed in accordance with an especially preferred embodiment of the present invention.

### DETAILED DESCRIPTION OF THE INVENTION

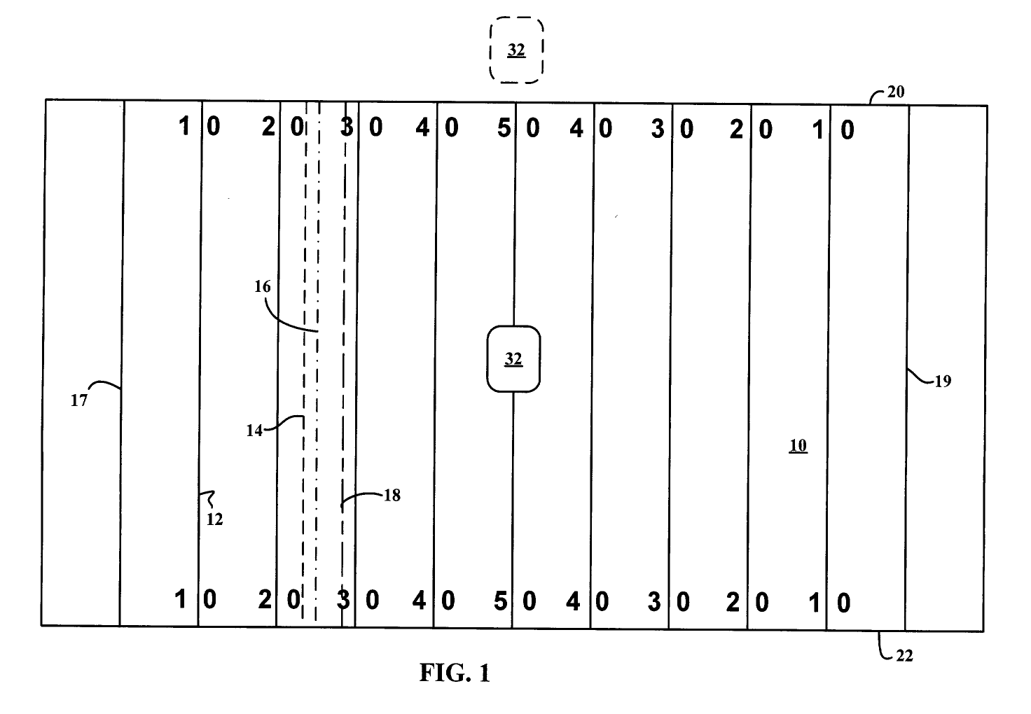

Referring to the drawings, and more particularly to FIG. 1, there is shown a football field surface 10 with yard lines 12 extending across the field at evenly spaced intervals. During the course of play, certain lines of demarcation are used. Of particular significance, and as illustrated in FIG. 1, are the initial scrimmage line 14, present scrimmage line 16 and first down ten-yard line 18. Other lines of significance on the surface of athletic field surface 10 include first and second goal lines 17 and 19, a first lateral boundary 20 and a second lateral boundary 22.

In accordance with the present invention, a system for superimposing a visibly illuminated line over one of the aforementioned lines 14, 16 and 18 is provided. In the illustrative embodiment of the present invention, the system 30 includes a temporary visible line marking apparatus 32 disposed directly above the athletic field (at, for example, a distance of from about 50 to 500 feet) at its midpoint. As will soon became readily apparent, such an arrangement is especially easy to implement using a single, scanning beam laser source in that relocation of the temporary visible line requires only angular displacement of a single actuator about a horizontal axis transverse to field 10. Since such a configuration will generally only be practical in the event of a domed stadium, a “sidelines” location of temporary visible line marking apparatus 32 (shown in dotted line)—wherein the apparatus is offset from the center of field 10 but is otherwise positioned at a vertical location sufficient to provide access to the entire field—is also contemplated. Indeed, depending upon budget, safety and access considerations, more sophisticated installations—for example, with the apparatus 32 being movable linearly along a track from one end of field 10 to the other or even positioned at one of the field—might be practical.

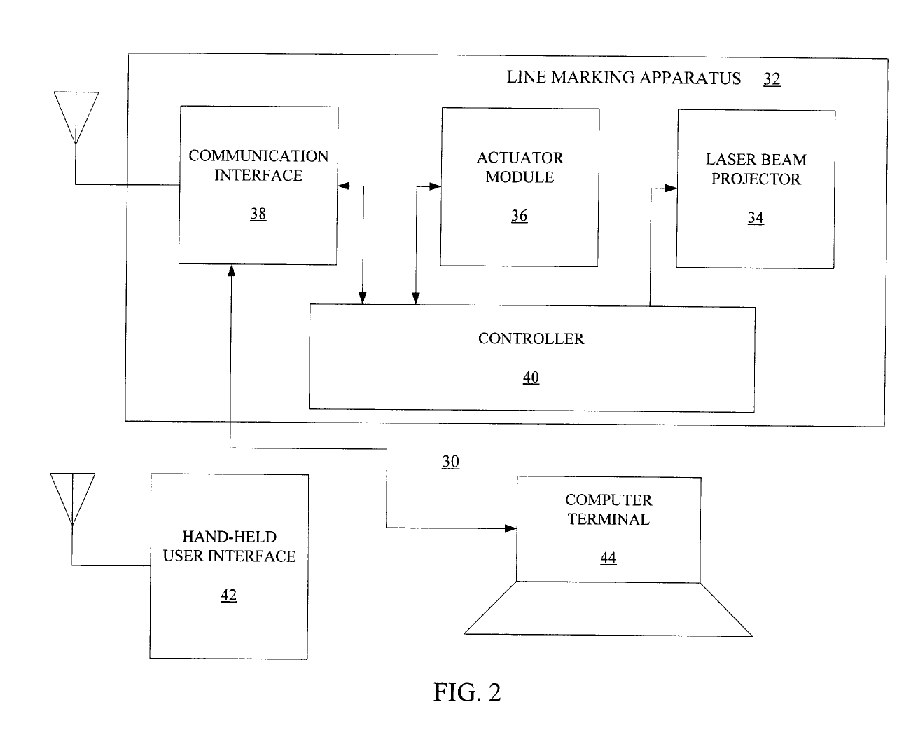

In any event, and with reference now to FIG. 2, it will be seen that the line marking apparatus 32 of system 30 includes a laser beam projector 34, an actuator module 36 for positioning of laser beam projector 34, a communication interface 38, with each of these being operative under the control of a controller indicated generally at 40. Advantageously, operation of line marking apparatus 32 is remotely controlled by a hand-held, portable user interface 42. Initialization of the system, and calibration of its respective components, is achieved using a PC terminal indicated generally at reference numeral 44.

The laser beam generated by beam projector 34 may be by any conventional well-known apparatus. Out of considerations of safety for the players on the field, the intensity and power of a beam emitted within the visible portion of the optical spectrum should be at the minimum level of power and intensity to achieve the objectives. In that regard, it should be noted that under current U.S. law, any party conducting a laser show or demonstration must apply for a “variance” to the Center for Devices and Regulatory Health (CDRH), a division of the Food and Drug Administration (FDA). Performers are permitted to have lasers on them under specified conditions. Generally, eye-safety issues are addressed by ensuring that the beam has a relatively large diameter, and by keeping the power level low. According to FDA regulations, employees (e.g., football players) can be exposed to Class II and IIa laser radiation levels as long as any direct viewing is only by accident for very brief periods. Preferably, however, the parameters of beam width, output power level and distance relative to field 10 are selected such that individuals standing on the field are only exposed to Class I radiation levels. In practice, the measurable irradiance at any point accessible to a person standing on field 10 (e.g. by jumping) should not exceed 10 milliwatts per centimeter squared, or 100 watts per meter squared.

Since 1972, there has been an internationally agreed upon hazard concept: the “MPE” or Maximum Permissible Exposure. Actually, the MPE includes many different exposure limits, depending upon the laser wavelength and time of exposure. The MPE for a given wavelength and exposure duration means: 10 times less than the light level where 50% of subjects' eyes had visible damage. Expressed another way: shining light at the MPE level into a subject's eye has a statistical chance of damaging 3 out of every 100 subjects. In summary, the MPE is a “worst case” safety factor. Exposure at the MPE level is already somewhat hazardous, so additional factors such as a moving (i.e., scanning) beam are assumed to further reduce risk. A typical requirement of the CDRH is that a failsafe be provided to rapidly block emissions by the laser in the event of a scanner failure—a safety feature that prevents a stationary beam from being directed into the eye for an impermissibly long interval. High inertia scanners (i.e., those which take more than one second for the scanning beam to stop moving) are considered relatively safe since they provide ample time for the actuation of a shutter (not shown). Thus, in an illustrative embodiment of the invention, laser projector 34 includes both an inertial scanning mechanism (not shown) for repetitively sweeping the laser beam to form a visible line on field 10 and a shutter (not shown) designed to stop light output in the event that mechanism fails.

The failure of low inertia scanners (less than 1 second to stop), galvanometer scanners and AO deflectors are harder to detect within a time window sufficient to enable activation of even a very fast failsafe shutter like a PCAOM. Nonetheless, as shutter technologies advance, it is contemplated that systems constructed in accordance with the present invention could be configured to make use of them. Moreover, alternate arrangements—using a light beam emitted at a wavelength from the non-visible portion of the electromagnetic spectrum (e.g., an ultraviolet wavelength) might be used to stimulate phosphorescent compounds pre-applied to a surface of field 10. An illustrative system of this type is disclosed in U.S. Pat. No. 5,174,571 issued to Aubusson et al. on Dec. 29, 1992.

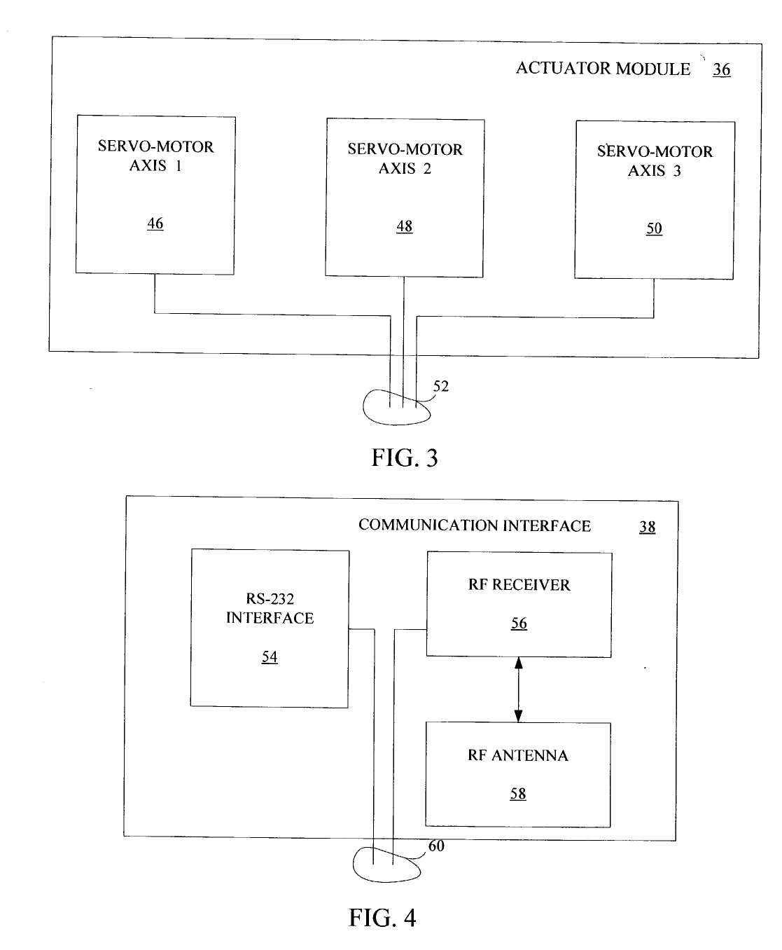

Turning now to FIG. 3, there is shown an illustrative 3-axis embodiment of an actuator module constructed in accordance with an exemplary embodiment of the present invention. As noted previously, when apparatus 32 is positioned at the location shown in solid line form in FIG. 1, only a single axis of movement is required to advance a line created by laser beam projector 34 from one end of field 10 to the other. However, in the dotted line location, additional adjustments in the position of laser beam projector 34 would be required in order to produce a consistently transverse line across field 10 as that line advances from end 17 to end 19. To this end, exemplary actuator module 36 incorporates three servo motors—indicated generally at reference numerals 46, 48 and 50—for independent angular displacement about first, second and third axes. The respective control wires for each servomotor are grouped in a bus 52 for connection to controller 40.

With reference now to FIG. 4, there is shown an illustrative communication interface for use in a line marking apparatus 32 constructed in accordance with the present invention. To receive operating commands from wireless communication with portable, wireless, hand held user interface 42, apparatus 32 includes an RF receiver 56 and an RF antenna 58. An RS-232 interface, indicated generally at 54, is also provided in order to facilitate initialization and calibration of the servomotors and other elements of system 32. Electrical connections from RF receiver 56 and RS-232 interface to controller 40 are achieved by wires 60.

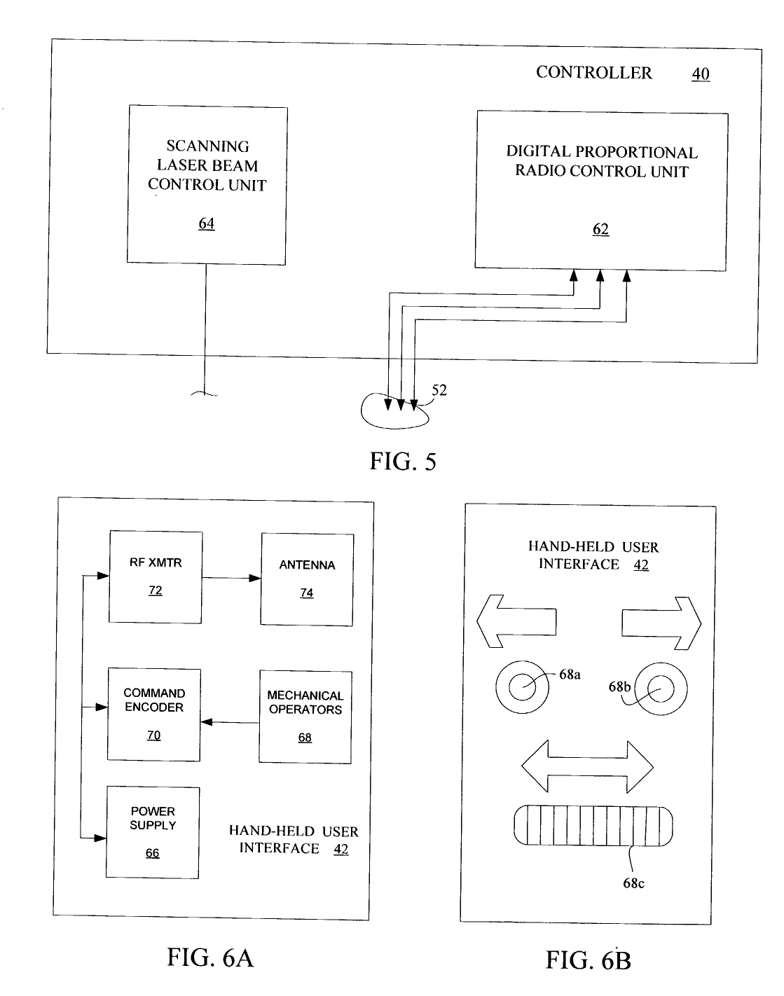

As seen in FIG. 5, a controller 40 constructed in accordance with an illustrative embodiment of the present invention includes a scanning laser beam control unit 64 and a digital proportional radio control unit 62. In accordance with an especially preferred embodiment of the invention, laser beam projector 34 (FIG. 2) is configured as an integrated, self-contained system that includes a laser emitter, collimating optics, a scanning mirror or deflector, and a power supply all disposed within a housing. Such packages are available commercially and can be simply and easily programmed to sweep an area so as to define any desired visible pattern. In accordance with such an embodiment, laser beam control unit 64 is operative to either energize or de-energize laser beam projector 34. Digital proportional radio control unit 62, in this embodiment, serves to execute commands received from the remote user interface by producing either coarse or fine angular adjustments in the positioning of the laser beam projector.

As seen in FIGS. 6A and 6B, a hand held user interface constructed in accordance with an illustrative embodiment of the present invention includes a battery-powered power supply 66, mechanical operators 68 for enabling a supervisory official to input commands directing apparatus 32 to reposition a temporary line marker, a command encoder 70 responsive to encode the manually entered input, and a wireless transmitter—such as RF transmitter 72—configured to transmit operating commands to the communication interface 38 of apparatus 32. With particular reference to FIG. 6B, it will be seen that the exemplary handheld user interface employs two different types of mechanical operators. For quick, “up the field” movements of the temporary line marker, first and second pushbuttons—indicated generally at reference numerals 68a and 68b, respectively, are provided. While one of these pushbuttons are depressed, movements implemented by actuator module 36 occur at a rapid continuous pace, with the line marker advancing in the direction of the arrow corresponding to the pushbutton depressed. For finer movements, a rotary actuator or thumbwheel 68c is provided—thereby taking advantage of the ability of digital proportional radio control unit 62 to obtain precisely controlled operation of actuator module 36. In accordance with an especially preferred embodiment of the invention, this rotary actuator -when properly calibrated—is operated to advance the marker by a precise distance calculated by the user, such that an advance of ten yards may be determined without even examining the markings on the field. If desired, one or more additional pushbutton operators (not shown) may be included in order to advance (or reverse) movement of the visible line by a predetermined amount (e.g., ten yards forward for a first down, five or fifteen yards back for a specified penalty, and so on).

Assuming that the direction of play is to the left or downfield, as viewed in FIG. 1, and a first down has just been made, the supervisory official manipulates one or more of the mechanical operators so that laser projector 34 is angularly displaced about at least one axis and the trailing edge of a visible line transverse to the field advances to a point of intersection with a designated spot on the ball. This spot is preferably the forward tip of the ball. Using the “fine control” mechanical operator, which provides equal, incremental movements, the first down line now advances by ten yards to the location of the new first down line.

Until another first down play is made, beam projector 34 continues to direct the line marker at the present first down line. Thus, after each down, the officials, players, and members of the audience have a continuous visible indication of the offensive team's proximity to the crucial first down line. When a new first down play is made, the position of the ball is marked as before and the line is advanced ten more yards, as before, to the new first down line.

This arrangement, while incredibly simple in its implementation, presents several advantages to the owners of teams whose games are televised. In addition to the obvious cost savings in labor, the vastly reduced amount of time needed to make the first down measurement determination afforded by the present invention presents an opportunity to sell significantly more advertising time during the televised games. Moreover, the present apparatus provides a more effective method of determining the measurement for first downs and eliminates both the guesswork and human error in making such a determination.

It will be appreciated that certain changes may be made in the various illustrative embodiments described above without departing from the scope of the invention, the latter being limited only by the claims which are appended hereto.

What is claimed is:

1. A system for dynamically marking an athletic field surface with a temporary, visible line, the field having a first end, a second end, a first lateral boundary and a second lateral boundary, the system comprising:
at least one laser source capable of producing a beam of radiation;
an actuator assembly operatively associated with the at least one laser source, said actuator assembly being dimensioned and arranged to direct the beam produced by the at least one laser source onto the athletic field surface;
a controller operative to control said actuator assembly so as to produce angular displacement of the beam produced by the at least one laser source, said laser source being operative to produce a beam which strikes the athletic field surface along a visible line extending from the first lateral boundary to the second lateral boundary of the athletic field surface; and
a portable, handheld user interface, said user interface including a wireless communication interface for establishing communication with said controller,
wherein said controller is responsive to transmissions received from the portable, handheld user interface to cause said visible line to advance to any selected position between the first end and the second end and to energize and de-energize the laser beam.

2. The system according to claim 1, wherein said laser source and said actuator assembly are configured for mounting directly above the athletic field.

3. The system according to claim 1, wherein said actuator assembly includes a servomotor for angularly displacing said at least one laser source about a first horizontal axis.

4. The system according to claim 3, wherein said actuator assembly further includes a second servo motor for angularly displacing said at least one laser source about a vertical axis.

5. The system according to claim 3, wherein said actuator assembly further includes a second servo motor for angularly displacing said at least one laser source about a second horizontal axis transverse to said first horizontal axis.

6. The system according to claim 1, wherein said laser source is adapted to generate a scanning beam for producing said visible line.

7. The system according to claim 1, wherein said portable, hand-held user interface includes a manual operator for energizing and de-energizing the laser source.

8. The system according to claim 1, wherein the hand held user interface includes a rotary operator, and wherein said controller includes a digital proportional control module responsive to movement of said rotary operator to produce slow, finely controlled movement of the visible line between the first end and the second end of the athletic field.

9. The system according to claim 8, wherein the hand held user interface includes a first manual operator and a second manual operator, and wherein said controller is responsive to actuation of said first manual operator to produce fast, coarsely controlled movement of the visible line between the first end and the second end of the athletic field.

10. The system according to claim 1, wherein the said portable user interface includes an RF transmitter for establishing communication with said controller.

11. The system according to claim 1, wherein said portable user interface includes a battery powered power supply.

12. The system according to claim 1, wherein said portable user interface includes a display adapted to show a virtual position of the visible line prior to energization of the laser source.

13. A method of officiating a football game on a field surface having a first end, a second end, a first lateral boundary and a second lateral boundary, comprising:
providing a line demarcation system adapted to direct a light source at said field surface and to produce therewith a visible line extending between the first lateral boundary and the second lateral boundary;
using a hand-held, portable user interface, transmitting a command via a wireless link to the line demarcation system causing said visible line to move from a first transverse position on the field to a second transverse position on the field.

14. The method according to claim 13, wherein said transmitting step includes rotating a manual operator adapted to produce commands operative to initiate slow, finely controlled movement of the visible line.

15. The method according to claim 13, wherein said transmitting step includes depressing a manual pushbutton adapted to produce commands operative to initial fast, coarsely controlled movement of the visible line.

16. The method according to claim 13, wherein said first transverse position traverses a point of intersection with a designated spot on a football immediately after a first down play.

17. The method according to claim 14, wherein said second transverse position is a distance of ten yards from the first transverse position.
